(19) United States
(12) Patent Application Publication
(10) Pub. No.: US 2003/0054214 A1
(43) Pub. Date: Mar. 20, 2003

(54) Power generation plant and method of generating electric energy

(76) Inventor: Christoph Noelscher, Nuernberg (DE)

Correspondence Address: Siemens Corporation, Intellectual Property Department, 186 Wood Avenue South, Iselin, NJ, 08830, US

(21) Appl. No.: 09/952,809

(22) Filed: Sep. 14, 2001

(51) Int. Cl. H01M 8/06; H01M 8/12

(52) U.S. Cl. 429/20; 429/34; 429/17

(57) ABSTRACT

A high electric efficiency plant for generating electric energy is provided, comprising a module of high-temperature fuel cells with means for heating water steam, the heating means are connected with the steam feed of the steam turbine and a conduit for the feed of bleed steam from the steam turbine to a reformer. In such a plant, the module of high-temperature fuel cells generated thermal energy can be used to heat up water steam, which is relaxed in a steam turbine, before it is fed to the reformer.

### FIELD OF THE INVENTION

The invention relates to a power generation plant and a method of generating electric energy.

### BACKGROUND OF THE INVENTION

A power generation plant of high-temperature fuel cells has an especially high efficiency of generating electric energy. A high-temperature fuel cell is a fuel cell, whose electrolyte is an electrolyte of solid state (Solid Oxide Fuel Cell, SOFC) or of molten carbonate (Molten Carbonate Fuel Cell, MCFC).

For the operation of the power generation plant of high-temperature fuel cells, fuels of hydrocarbon, especially methanol, natural gas, mineral oil, Naphta or biogas are used. Normally, these fuels must be prepared in a suitable way, that means reformed for the operation of the high-temperature fuel cells, which are unified in modules of high-temperature fuel cells. These fuels of hydrocarbon are undergoing before the electrochemical reaction in the module of high-temperature fuel cells a process of reforming, which is accompanied by a process of moisturization, by which gaseous products of the process of reforming such as CO, H2, CO2 and H₂O are developing. These gaseous products of the process of reforming are the so called reformat and are now forming the suitable fuel gas for the operation of the module of the high-temperature fuel cell.

The process of reforming can be carried out externally or internally, that is, outside or inside the module of high-temperature fuel cells, and with or without the use of heat of the exhaust gas of the anode of the module of high-temperature fuel cells.

An internal process of reforming is known by the report “Verfahrenstechnik der Hochtemperaturbrennstoffzelle” of E. Riensche, VDI-Berichte 1174 (1995), page 63-78, which describes the use of the heat, which is generated during the electrochemical combustion, for the internal process of reforming of the fuel gas. If the process of reforming is carried out inside the module of high-temperature fuel cells, but outside the part of the anode of the module of high-temperature fuel cells, it is a so-called indirect process of reforming. A process of reforming inside the part of the anode is therefore called direct internal process of reforming.

Plants of fuel cells with one or several modules of fuel cells are constructed in such a way, that the electrical efficiency is high as possible. It is desirable to generate as much as possible electric energy given by a certain amount of fuel. During the electrochemical combustion of fuel gas in a module of high-temperature fuel cells much heat is developed, which should be used, if a high electric efficiency shall be reached. This thermal energy can be used for the process of reforming of the fuel to a fuel gas for instance.

The U.S. Pat. No. 3,982,962 describes an arrangement of two modules of high-temperature fuel cells in such a way, that a big part of the in the module of high-temperature fuel cells generated energy are used for the direct internal process of reforming. The hereby generated surplus of the fuel gas is fed to a second module of high-temperature fuel cells. The heat, which is generated in the second module, is used for heating water steam, which is fed to the reformer inside the first module. The other part of the heat of the second module is fed to a turbo charger, which compresses the oxidants for both modules.

The DE 196 36 738 Al proposes to use the thermal heat of the second module of high-temperature fuel cells for the actuation of a heat engine, which is coupled with a generator, by which the thermal energy of the second module is used for the generation of additional electric energy. By this the electric efficiency of the whole plant of high-temperature fuel cells is increased.

### SUMMARY OF THE INVENTION

It is the aim of the invention to describe a plant of generating of electric energy with an improved efficiency. Furthermore it is the aim of the invention to describe a method of generating electric energy with an improved efficiency.

The first aim is solved by a plant of generating electric energy, which comprises a reformer, at least one module of high-temperature fuel cells with means for heating water or water steam, a steam turbine whose steam duct is connected with these means and a duct which is used to feed steam from the steam turbine to the reformer.

Such a plant is suitable to use the thermal energy, which is generated in the module of high-temperature fuel cells, to evaporate water and to heat water steam, and to feed the heated water steam to a steam turbine. With a generator, which is connected with the steam turbine, waste heat of the module can also generate additional electric energy. Furthermore such a plant can feed bleed steam from the steam turbine to the reformer. The reformer can be arranged either inside a module of high-temperature fuel cells or outside the module.

Inside the steam turbine a part of the thermal energy is transformed in electrical energy, which leads to a high efficiency, because the waste heat of the steam turbine has no loss, since it is fed to the reformer. Due to the arrangement of the steam turbine between the module of high-temperature fuel cells and the reformer, a part of the thermal energy, which is generated inside the module, is separated and transformed in electrical energy in the steam turbine. This three-step-process, by which electric energy is generated in the module of high-temperature fuel cells, by which the waste heat from this process is used to generate electric energy and the use of the residual waste heat to generate fuel gas, especially for the generation of hydrogen H2, a very efficient process with a high exploitation of the energy content of the fuel is provided.

With such a plant the advantage of the efficient exploitation of energy is combined with an another advantage: The inside the module of high-temperature fuel cells generated heat is sufficient enough to generate a high amount of steam. By the input of steam to the reformer a high amount of fuel gas of hydrogen can be reformed inside the reformer. The hydrogen from the fuel gas can be fed to another purpose outside the plant for generating electric energy. It is also possible to use the fuel gas inside the module of high-temperature fuel cells.

It is useful to arrange the reformer inside another module of high-temperature fuel cells. The plant comprises a first module of high-temperature fuel cells that comprises means of heating water or water steam and a second module of high-temperature fuel cells with a reformer. This second module is e.g. smaller dimensioned than the first module. Because the heat from the steam of the first module is fed to it, it can supply the bigger first module completely with fuel gas.

With such a plant the inside the first module generated thermal energy is transformed by the steam turbine and the following generator in additional electric energy. This leads to high electric efficiency. Furthermore the second module can be smaller dimensioned in relation to the first module, which leads to cost savings during the build up of the plant.

Preferably, a burner and a gas turbine are arranged beside the module of high-temperature fuel cells at the anode with its exhaust gas, whereby the gas turbine and the steam turbine are part of a gas and steam plant. Such a plant for generating electric energy is suitable to generate electric energy with only one module of high-temperature fuel cells in an efficient way. As described above, a high amount of fuel gas can be generated by the recirculation of steam from the steam turbine to the reformer. This amount of fuel gas e.g. is so high, that the fuel gas is not completely transformed in electric energy in the module of high-temperature fuel cells by electrochemical reaction. A part of the fuel gas passes the module without being consumed. If more fuel gas passes the high-temperature fuel cells as it is consumed, it leads to an especially high exploitation and by this to a high efficiency of the cells.

In a burner, which is arranged in the module beside the anode with its exhaust gas, the surplus of the fuel gas is burned and with the waste gas of the burner a gas turbine is actuated. The waste gas of the gas turbine is again used to heat up water steam, whose thermal energy is transformed by relaxation in the steam turbine in electrical energy. With this arrangement of the plant the module of high-temperature fuel cells can be operated with a high efficiency. These turbines, which are arranged behind the fuel cells, lead to generation of additional electric energy, so that the three components, the module of high-temperature fuel cells, gas turbine and steam turbine can be operated together in such a way that each component is charged to capacity in a very best way. By this the plant is operated with a very high efficiency and very economically.

The second task of the invention is solved by a method of generating electrical energy, by which fuel is reformed to fuel gas in the reformer, fuel gas is transformed in heat and electric energy in the module of high-temperature fuel cells, water steam is heated with a part of this heat, which is fed to a steam turbine and feeding bleed steam of the steam turbine to the reformer.

The electrical efficiency of the plant of generating electric energy is so much higher the more thermal energy, which is generated in the plant, is transferred into electrical energy. Since the electrical energy per given content of energy can be sold higher than thermal energy, a higher electric efficiency of the plant leads to a more cost effective utilization of the plant. The electric efficiency of the plant of generating electrical energy is not only dependent of the design but also from the method, with it is operated. By heating of water steam with thermal energy from the module of high-temperature fuel cells and the operation of the steam turbine with a generator, a part of the thermal energy, which is generated from the module of high-temperature fuel cells, is transformed in electric energy. This leads to a good electric efficiency of the plant.

Normally the waste steam of the steam turbine is condensed because of thermodynamic reasons, heated up in turn and fed to the steam turbine. In this process a part of the thermal energy of the waste steam is lost. If the steam is bled from the steam turbine, after a certain amount of relaxation, and fed to the reformer, then the content of thermal energy of the bleed steam is used in the reformer for reforming of the fuel gases. Hereby a lost of waste heat is avoided by which the plant of generating electrical energy can be operated more cost effective. Furthermore this method has the advantage, that a high amount of water steam can be supplied to the reformer. Hereby the reformer can be operated in such a way, that much reformat can be generated. If the reformer is integrated in the module of high-temperature fuel cells and the reforming is carried out in the part of the anode of the module of high-temperature fuel cells, then the module can be operated with this method in such away, that much heat and much electric current can be produced. By the generation of much reformat a high utilization of the cells is reached. A high utilization of the cells is leading to a high efficiency of the whole fuel cell.

Practically the bleed steam is fed to the reformer having the same pressure. Hereby the place of taking out in the steam turbine is chosen in such away, that the pressure of the taken out steam is suitable for the reformer. This has the advantage, that no reduction means for the pressure of the bleed steam must be installed in the plant.

Preferably a part of the fuel gases can be burned in a burner and with the waste gas of the burner a gas turbine can be operated. The energy content of the fuel gases, which is generated by thermal energy, is transformed partly in the gas turbine in electric energy. In a preferred arrangement of the steam turbine behind the gas turbine another part of the energy content of the fuel gas can be used for the production of electric current by the steam turbine.

Practically at least 40% of the heat, which is generated in the module of high-temperature fuel cells, is fed to the steam turbine. Using the heat from the module of high-temperature fuel cells to heat up the fuel gas which is flowing into the module, only a part of the in the module generated heat is fed to the steam turbine. If at least 40%, especially more than 60% of the heat is fed to the steam turbine, then the dimension of the steam turbine and the module of high-temperature fuel cells have a good relation to each other. This leads to a high electrical efficiency of the whole plant.

Practically the water steam is heated up inside the modules of the high-temperature fuel cells. This is a method with a low lost of heat during the feed of the heat from the module of high-temperature fuel cells to the steam. Preferably the module of high temperature fuel cells is designed in such a way, that it can stand a pressure of the water steam up to 100 bar. Hereby it is possible, that the water steam is heated up in the module and fed to the steam turbine with a high pressure. Hereby a very low lost of thermal energy is reached.

In another advantageous design of the invention the fuel is reformed in another module of high-temperature fuel cells and this module is operated with the voltage of the cell below 0,8V, especially below 0,65V. During the operation of the high-temperature fuel cell with the low operation voltage a high level of power of the fuel cell is reached. During the operation of the high-temperature fuel cell below 0,8V, especially 0,65V or even below that, much heat is also generated. This heat is used for the operation of the steam turbine and by this for the generation of electrical current and also for the reforming of the fuel gases.

The reformer can generate preferably more reformat, especially more hydrogen than it is consumed in the modules of high-temperature fuel cells. With this kind of the method the high-temperature fuel cell can be operated in such a way that a surplus of hydrogen is generated leading to a high efficiency of the cells. The cells are reaching by this a high electrical efficiency. Furthermore the surplus of hydrogen can be separated and fed to a consumer outside the plant of generating electrical energy. In the industry hydrogen is consumed largely, so that this method is an additional source for the operator of the plant of generating of electrical energy. Hereby the plant can be operated very cost effective.

### BRIEF DESCRIPTION OF THE DRAWINGS

Examples of the invention are described in three figures.

FIG. 1 shows the plant for generating of electrical energy in a schematic arrangement with two modules of high-temperature fuel cells;

FIG. 2 shows the plant in a simplified illustration for generating electrical energy; and

FIG. 3 shows a plant for generating electrical energy with only one module of a high-temperature fuel cell.

### DETAILED DESCRIPTION OF THE PREFERRED EMBODIMENT

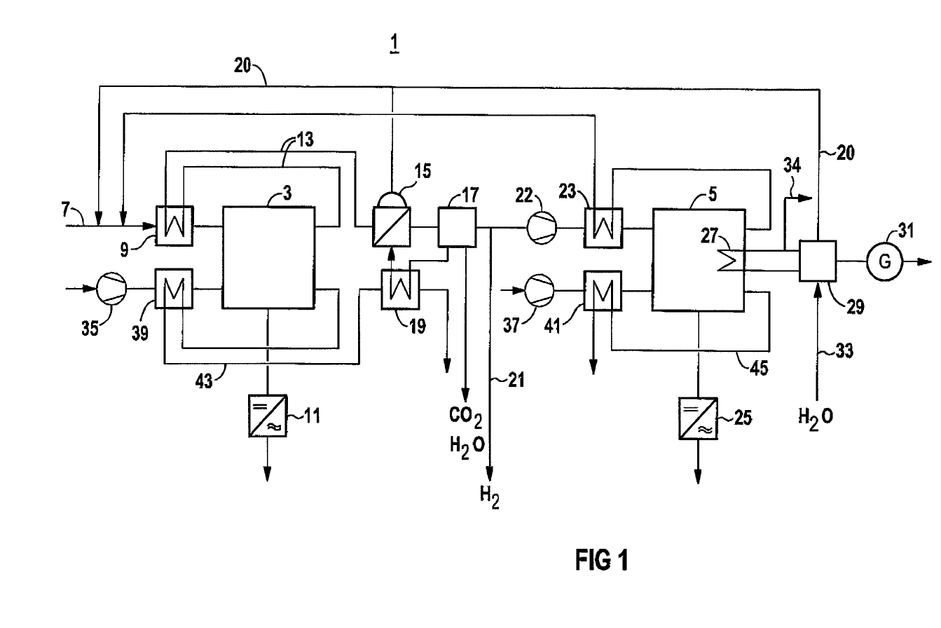

In FIG. 1 a power generation plant 1 for generating electrical energy is shown in a schematic illustration, which comprises a first module of high-temperature fuel cells 3 and a second module of high-temperature fuel cells 5. In the first module 3 the part of the anode is constructed in such away that it is used for reforming fuel to a fuel gas. The second module 5 has no internal reforming. The fuel cells of both modules are of the type SOFC. During the operating of the plant natural gas as fuel is fed to a heat exchanger 9 through the conduit 7. The fuel is heated up there and subsequently fed to the first module of temperature fuel cells 3. In this module 3 the fuel is reformed into a fuel gas and a part of this fuel gas is transformed in electrical energy and heat by electrochemical reaction. A part of the heat is fed to the internal process of reforming in the module 3. The reforming process cools the module 3. The electrical energy is fed to a electrical rectifier 11, which is connected to a power supply system. The exhaust gas of the module 3 has a high content of fuel gas and heat. It is fed through the conduit 13 to the heat exchanger 9, where heat is fed to the fuel. Subsequently the exhaust gas is fed through the conduit 13 to a vaporizer 15 and subsequently fed to a gas washer 17. In this gas washer 17 CO₂ is separated from the exhaust gas and fed and water is also separated, which is heated up again in a heat exchanger 19 and in a vaporizer 15, in order to be fed through the conduit 20 and to the mixed with the fuel.

The exhaust gas of the anode, which leaves the gas washer now has a high content of hydrogen. A part of the hydrogen (H₂) of the exhaust gas of the anode is fed through the conduit 21 outside the plant of generating electrical energy. The residual exhaust gas of the anode is passing through a compressor 22 and subsequently through a heat exchanger 23, where it is heated up and finally fed to a second module of high-temperature fuel cells 5. In this second module 5 a part of the hydrogen from the washed exhaust gas of the anode is transformed in electrical energy by electrochemical reaction in the first module, which is fed to a rectifier 25 and fed subsequently to a power supply system. Since the fuel cells of the second module 5 generate a surplus of hydrogen in order to reach a high utilization of the cells, the exhaust gas of the anode is fed to the conduit 7 through a heat exchanger 23 and by this fed to a circulation. The second module of high-temperature fuel cell 5 has means 27, in which water steam is generated and heated with the heat of the module 5. These means 27 are e.g. an apparatus which can stand a pressure of the water steam up to 100 bar, for example a vaporizer or a heat exchanger. The pressurized water steam is fed to a steam turbine 29, which transforms the thermal energy from the module 5 in mechanical energy. A generator 31, which is arranged behind the steam turbine, transforms the mechanical energy into electric energy. A part of the steam turbine 29 is fed through the conduit 20 to the conduit 7. From this, the steam is arrived in the first module 3, where it is used for the reforming of the fuel gases. The steam, which is not consumed during the reforming circulates during stationary operation without condensing. The water, which is taken out from the steam turbine 29 with the bleed steam, is replaced by new water through the conduit 33. Heated water steam can be fed directly to the conduit 20 and the conduit 7 through the conduit 34 in the means 27. Such a feed of the steam is for instant useful during starting of the plant 1.

The supply of oxidants for both modules 3 and 5 is performed in a similar way. Through a compressor 35, 37 air is absorbed, each fed to a heat changer 39, 41 in order to be heated up, and fed to the cathode in the respective module 3, 5. Inside the modules 3, 5 the oxidants are reacting with the fuel gas in a electrochemical reaction and electric energy is generated. The exhaust gas from the cathode of the modules 3 and 5 are fed through the conduits 43, 45 to the heat exchangers 39, 41. The exhaust gas of the cathode of the module 3 is additionally passing through the heat exchanger 19. Subsequently the exhaust gases are leaving the plant 1 as waste air.

The high-temperature fuel cells of the module 3 are operated with a voltage of the cells below 0,65V. Hereby much heat is generated in the module 3 and more hydrogen is generated with this heat than hydrogen can be consumed in the module 3 and 5. More than 25% of the in the module 3 generated hydrogen is utilized outside the plant. The thermal energy of the module 5 is fed partly to the fuel gas of the module 5 in the heat exchangers 23 and 41. More than 60% of the in the module 5 generated thermal energy is fed to the steam turbine 29 and is used for the production of electric current by the generator 31. More than 10% of the steam, which is passing through the steam turbine 29, especially more than 25% and even more than 50%, are bled from the steam turbine 29 and fed through the conduit 20 to the fuel in the conduit 7 having the same level of pressure. This method makes it possible to supply the reformer in the module 3 with sufficient steam for the production of a surplus of hydrogen.

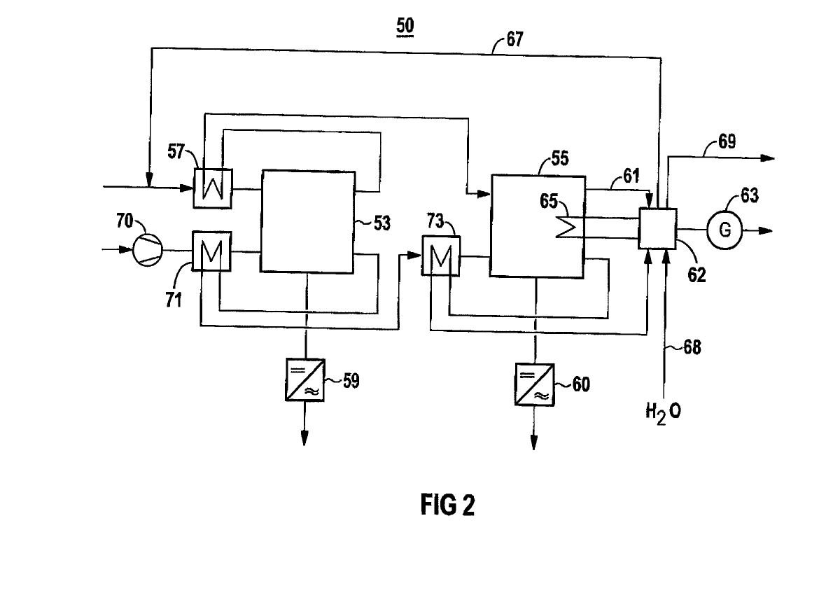

FIG. 2 shows schematically a plant 50 for the generating of electric energy, which is constructed in a more simply way compared to the plant 1 of FIG. 1.

The plant 50 comprises a module of a high-temperature fuel cells 53 of the type SOFC with internal reforming at the exhaust gas of the anode and a second module of high-temperature fuel cells 55, which is also of the type SOFC. Natural gas is fed to the module 53 as fuel. The fuel is heated up in the heat exchanger 57, subsequently fed to the module 53 and finally reformed to fuel gas, which is used to generate electric current, which is fed to the rectifier 59. The exhaust gas of the anode is passing through the heat exchanger 57 and subsequently fed to the module 55.

The electric current, which is generated in the module 55, is fed to the rectifier 60. The exhaust gas of the anode of the module 55 is fed through the conduit 61 to a plant 62 of a combined steam and gas plant, which comprises a burner, in which the exhaust gas of the anode is burnt, and a not detailed shown gas turbine, which is operated with the exhaust gas of the burner.

A generator 63 is used for the generation of electric energy, which is arranged behind this gas turbine. In the plant 62 a steam turbine is also arranged, which is not detailed shown, which is combined with means 65, which are used to heat up the water or water steam inside the module 55. With this generated water steam the steam turbine is operated, which generates in corporation with the generator 63 electric current. A part of the steam of the steam turbine is fed through the conduit 67 to the fuel input and by this fed to the module 53 having he same level of pressure. The water, which is taken out by this, is replaced by new water, which can be supplied through the conduit 68 to the plant 62. The exhaust gas of the plant 62 is bled off through the conduit 69. The module 53 is operated in such a way, which makes it possible to generate more fuel gas than it can be consumed in the modules 53 and 55.

The supply of oxidants for the modules 53 and 55 is performed by a compressor 70, by which additional air is fed firstly through the heat exchanger 71 and subsequently to the module 53. The exhaust gas of the cathode of the module 53 is again passing through the heat exchanger 71 in order to heat up the additional air, and is subsequently also heated up in the heat exchanger 73 and finally fed to the module 55. The exhaust gas of the anode of the module 55 is again fed to the plant 62 through the heat exchanger 73. In the plant 62 the exhaust gas is fed to the burner.

The modules 53, 55 and the plant 62 are adjusted in their dimension in such a way, that they can be charge to capacity at a high level. The efficient utilization of the thermal energy, which is generated in the modules 53 and 55, to generate electric energy makes it possible to operate the plant 50 with a high efficiency and very cost effectively.

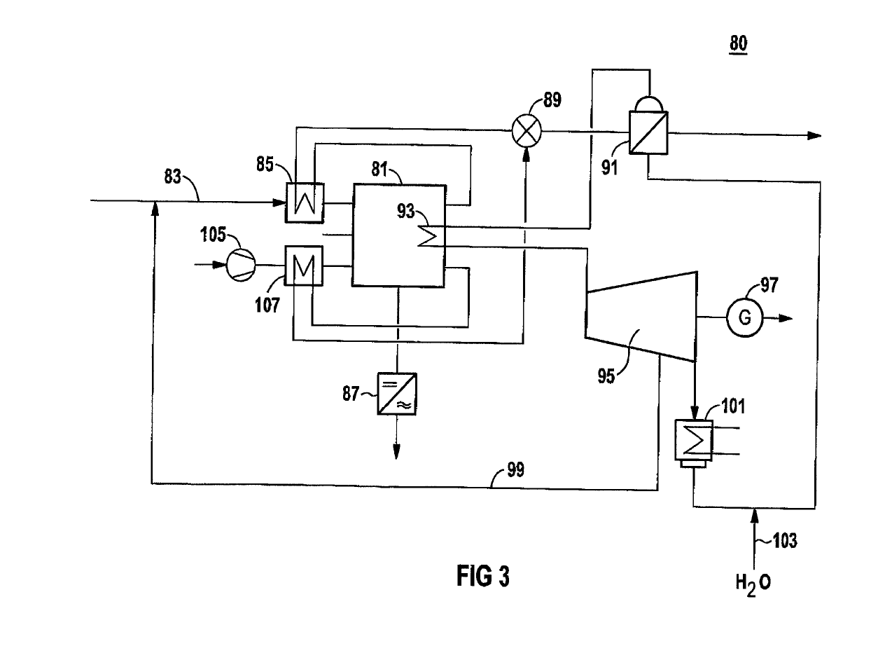

FIG. 3 shows a plant 80 of generating electric energy with only one module of high-temperature fuel cells 81 with internal reforming. The module 81 is suitable for the reforming of methanol, which is fed to a heat exchanger 85 through a conduit 83, being heated in the heat exchanger 85 and subsequently fed to the module 81. In the module 81 the methanol is reformed into fuel gas and used for the generation of electric current, which is fed to a rectifier 87. The exhaust gas of the anode feeds the heat exchanger 85 with heat and is burnt in a burner 89 and subsequently fed to a vaporizer 91, in which the thermal energy of these burnt exhaust gases of the anode are used to vaporize water. Finally the exhaust gas is bled off the plant. In the vaporizer 91 vaporized water is heated up in the module 81 with their means 93 for heating up water steam and subsequently fed to a steam turbine 95. The steam turbine 95 generates electric current with the generator 97, which is arranged behind the steam turbine 95. A part of the bleed steam of the steam turbine 95 is fed to the conduit 83 through the conduit 99 and by this mixed with the fuel, accessing by this the reformer of the module 81. Another part of the steam relaxes in the steam turbine, is condensed in a condenser 101 and subsequently fed in turn to the vaporizer 91. The bleed steam from the steam turbine 95, which is fed to the reformer, is replaced by new water, which is loaded through the conduit 103 to the circuit of the steam turbine 95, which is heated up in the vaporizer 91.

Air, which is compressed by the compressor 105, is fed to the cathode of the module 81, which was also heated up before in the heat exchanger 107. The exhaust gas of the cathode is fed firstly to the heat exchanger 107 and subsequently to the burner 89.

Although this invention has been described in terms of certain exemplary uses, preferred embodiments, and possible modifications thereto, other uses, embodiments and possible modifications apparent to those of ordinary skill in the art are also within the spirit and scope of this invention. It is also understood that various aspects of one or more features of this invention can be used or interchanged with various aspects of one or more other features of this invention. Accordingly, the scope of this invention is intended to be defined only by the claims that follow.

1. A power generation plant for generating electric energy, comprising:
a reformer;
at least one module of a high-temperature fuel cell having means for heating water or water steam;
a steam turbine having a duct connected to the heating means; and
a conduit that feeds the heated water or water steam from the steam turbine the reformer.

2. The plant according to claim 1, wherein the reformer is arranged within a second module of high-temperature fuel cells.

3. The plant according to claim 2, wherein at the module of the high-temperature fuel module, a burner and a gas turbine are arranged behind the exhaust gas of the anode and wherein the gas and the steam turbine are part of a GuD plant.

4. A method of generating electric energy comprising following steps:
a) reforming fuel to a fuel gas inside a reformer;
b) transforming the fuel gas into heat and electric energy in a module of high-temperature fuel cells;
c) using at least a portion of the heat to heat water steam and feeding the water steam to a steam turbine; and
d) feeding bleed steam of the steam turbine to the reformer.

5. The method according to claim 4, wherein a portion of the fuel gas is burnt and the exhaust gas of the burner is used to actuate a gas turbine.

6. The method according to claim 4, wherein at least 40% of the heat which is generated in the module of high-temperature fuel cells is fed to the steam turbine.

7. The method according to claim 4, wherein the water steam is heated up inside the module of high-temperature fuel cells.

8. The method according to claim 4, wherein the fuel is reformed in another module of high-temperature fuel cells and the other module of high-temperature fuel cells is operated with a voltage below 0,8V.

9. The method according to claim 4, wherein the fuel is reformed in another module of high-temperature fuel cells and the other module of high-temperature fuel cells is operated with a voltage below 0,65V.

10. The method according to claim 4, wherein the reformer generates more hydrogen than is consumed in the modules of high-temperature fuel cells.
